(19) United States
(12) Patent Application Publication
(10) Pub. No.: US 2010/0148486 A1
(43) Pub. Date: Jun. 17, 2010

(54) Sheet articles

(76) Inventor: George Wallace McDonald, Channel Islands (GB)

Correspondence Address: GOODWIN PROCTER LLP;ATTN: PATENT ADMINISTRATOR, 620 Eighth Avenue, NEW YORK, NY, 10018, US

(21) Appl. No.: 10/504,783

(22) PCT Filed: Feb. 3, 2003
(86) PCT No.: PCT/GB03/00419

§ 371 Date: Aug. 14, 2006

(30) Foreign Application Priority Data
Feb. 16, 2002 (GB) 0203709.1

(51) Int. Cl. B42D 15/00; B65D 27/06

(52) U.S. Cl. 283/61; 229/92.1; 229/300; 281/2

(57) ABSTRACT

The invention provides a sheet article comprising a cover (4) comprising hingedly connected first (8) and second surfaces (6), a sheet material (12) being connected to the inside of the first surface, the second surface comprising a pocket (14), wherein the cover comprises a line of weakness (9) such that at least a portion of the first surface is removable by separation of the cover at the line of weakness, and the article comprises means for securably closing the pocket.

### FIELD OF THE INVENTION

The present invention relates to sheet articles.

### Background to the Invention

It is known to provide a sheet article comprising a first portion and second portion having a line of perforations therebetween, and in which the first portion contains information to be retained by a receiver of the article, and the second portion is arranged to be separated by tearing the perforations, the second portion then being returned to the sender of the article, generally after the receiver has added personal information to the second portion.

One advantage of providing sheet articles which require information to be recorded by a user and posted back to the sender, and in which a portion of the article can be retained by the user, is that the participating effect for the user encourages posting of the information back to the sender. The second portion must generally be placed in a separate envelope or, in certain articles folded up and formed into its own envelope which is then sealed by the user. In the former example, the need to provide a separate envelope and insert the second portion is time-consuming, a separate envelope is not always to hand, and the user incurs the cost of the separate envelope in many cases. In the latter case, the act of folding and adhering the second portion is again time-consuming and the resultant envelope, being a thin sheet is less secure than would be the case for depositing the second portion in a separate envelope.

It is known to provide sheet articles comprising card covers having first and second surfaces folded over to provide front and back covers, and which include a pocket formed on the inside of one of the covers. It is also known for such items to comprise a plurality of sheets glued into the fold of the cover to provide a booklet flanked by the front and back covers. Examples of this type of sheet article are described in U.S. Pat. No. 6,120,228, U.S. Pat. No. 6,089,608 and U.S. Pat. No. 5,595,401. This type of sheet article does not provide for the removal of any part of the article in order to retain information on that part, if the remainder of the article is to be posted to third party, and the part of the article to be posted would need to be deposited in a separate envelope before depositing.

It is therefore an aim of preferred embodiments of the present invention to overcome or mitigate at least one problem of the prior art, whether expressly disclosed hereinabove, or not.

### SUMMARY OF THE INVENTION

According to the present invention there is provided a sheet article comprising a cover comprising hingedly connected first and second surfaces, a sheet material being connected to the inside of the first surface, the second surface comprising a pocket, wherein the cover comprises a line of weakness such that at least a portion of the first surface is removable by separation of the cover at the line of weakness, and the article comprises means for securably closing the pocket.

Suitably a portion of the first surface, which portion includes the sheet material, is removable at the line of weakness.

Preferably the sheet material comprises a first set of folds. Suitably the first set of folds is concertina folds.

Suitably the sheet material further comprises a second set of folds transverse to the first set of folds. Preferably the second set of folds is concertina folds.

Suitably the sheet material is provided with a stiff portion at a segment thereof.

Suitably the sheet material is connected to the first surface at a segment of the sheet at one corner of the sheet the segment being defined by fold(s) or edge(s) of the sheet.

Preferably the segment at which the stiff portion is provided is at another corner of the sheet material and is defined by fold(s) or edge(s) of the sheet.

In an alternative embodiment the sheet material may comprise a plurality of sheets which are connected to form a booklet.

The sheet material may comprise a plurality of sheets which are connected to form a booklet, and in which at least one sheet comprises a first set of folds, preferably concertina folds, and preferably a second set of folds which may be concertina folds.

The sheet material may be a sheet material described in patent and patent application numbers EP288472B, EP72042B, WO92/1082, EP529037B, and GB 2262475B.

Suitably the sheet material comprises a line of weakness, or indicator means, such that in use, at least a portion of sheet material may be separated at the line of weakness or indicator means, and may be inserted into the pocket.

Preferably the line of weakness is perforations.

Suitably the indicator means comprises a coloured indicator line.

Preferably the first and second surfaces are formed from a single surface comprising a fold therein, the fold forming the hinged connection between the first and second surfaces.

Alternatively the first and second surfaces may comprise separate surfaces hingedly connected by way of gluing, stitching, stapling, binding or the like, for example.

Preferably the pocket is formed from a portion of the second surface folded in on itself, and sealed to the second surface to form a pocket. Suitably the pocket is sealed to the second surface by gluing, stitching, stapling, binding or the like.

Alternatively the pocket may be formed from a separate surface connected to the second surface of the cover such that an opening is formed. The separate surface may be connected by any suitable means, such as gluing, stitching, stapling, binding or the like.

The pocket may comprise a separate distinct pocket which is attached to the inside of the second surface. The separate pocket may be attached by gluing, stitching, stapling, binding or the like.

Suitably the pocket is formed such that it comprises no free edges within the interior of the pocket.

The edge of the opening of the pocket may comprise a recessed or cut-out portion, to enable a user to more easily grasp an article placed in the pocket.

The pocket may comprise means to retard accidental egress of an article from the pocket, but allow deliberate removal therefrom.

The pocket may be connected to the outside of the second surface, but is preferably connected to the inside of the second surface.

The pocket may be oriented such that the opening of the pocket faces transverse to, perpendicular to or away from the hinged connection between the first and second surfaces, but preferably the opening of the pocket faces the hinged connection.

The pocket may be divided into a plurality of pocket portions, each portion comprising a defined cavity having an opening. Preferably the opening of each pocket portion faces the hinged connection between the first and second surfaces of the cover.

There may be more than one pocket.

Preferably the means for securely closing the pocket comprises a pocket sealing means, whereby the pocket is sealable to provide a sealed pocket.

Suitably the means for securely closing the pocket comprises a portion of the cover which is movable to form a covering surface over the opening of the pocket.

Suitably the movable portion of the cover comprises the pocket sealing means, in order to seal the pocket. Thus the sealed pocket may form a sealed envelope.

Preferably the sealing means comprises an adhesive strip which comprises a detachable cover to prevent adhesion of the adhesive strip to the cover until desired. Alternatively the sealing means may comprise a strip of material which, when wetted, becomes adhesive, such as gum found on known envelopes and postage stamps, for example.

The line of weakness in the cover may be provided in the hinged connection between the first and second surfaces.

Preferably the line of weakness in the cover is provided in the first surface.

Preferably the line of weakness in the first surface is oriented such that when a portion of the first surface is removed at the line of weakness, the remaining portion of the first surface is movable about the hinged connection to effect the covering surface over the opening of the pocket.

The cover may comprise apertures which in use may be used to connect the sheet article to a ring binder, filofax or the like.

Suitably the sheet article is substantially credit-card sized, such that it may be retained in a pocket or wallet of a user, but the sheet material may be bigger or smaller than credit-card sized to accommodate sheet material of various sizes.

The first surface may comprise a cut-out portion over which the sheet material may be connected, such that information on the sheet material may be viewed through the cut-out portion.

### BRIEF DESCRIPTION OF THE DRAWINGS

For a better understanding of the invention and to show how the invention can be put into effect, embodiments will now be described by way of example, with reference to the accompanying drawings, in which:

FIG. 1A illustrates a plan view of a preferred embodiment of a sheet article of the invention;

FIG. 1B illustrates a separated sheet material of the sheet article of FIG. 1A in an unfolded configuration;

FIG. 2 illustrates a plan view of the cover of the sheet article of FIG. 1A, without the sheet material of FIGS. 1A and 1B connected;

FIGS. 3A and 3B illustrate plan views of the sheet article of FIG. 1A when the cover has been separated into a pocket portion and sheet material portion along the line of perforations; and

FIG. 4 illustrates the pocket portion of FIG. 3A wherein the remaining portion of the first surface of the cover was sealed the opening of the pocket.

### DESCRIPTION OF THE PREFERRED EMBODIMENTS

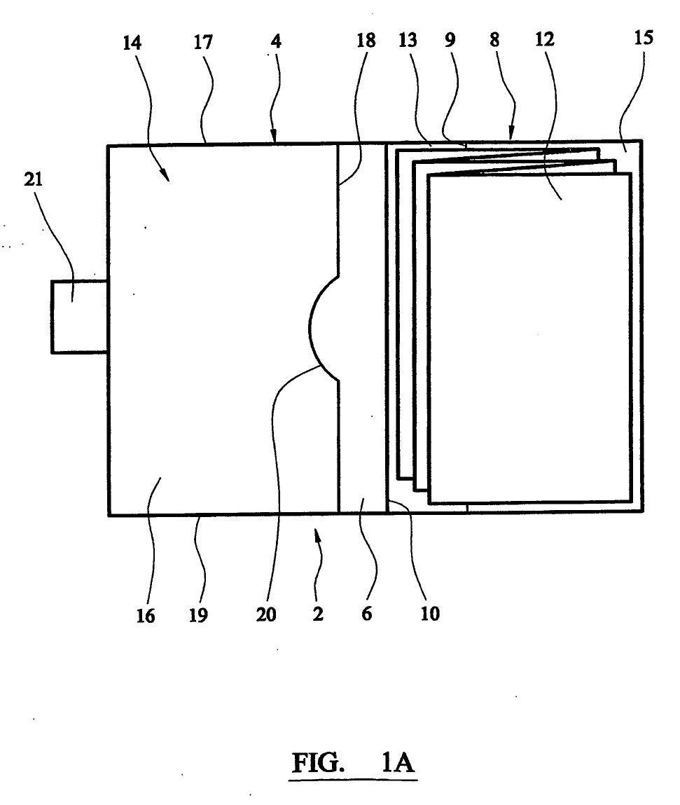

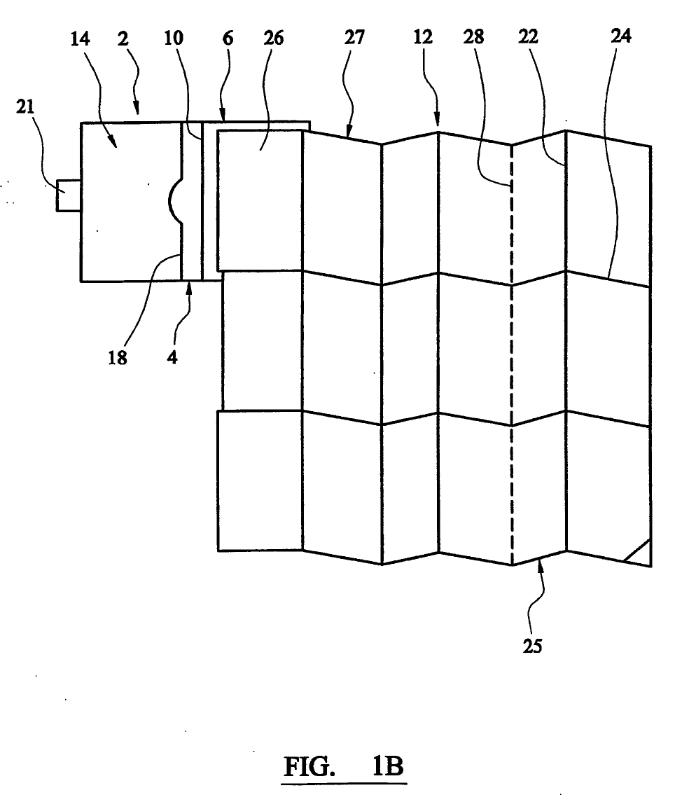

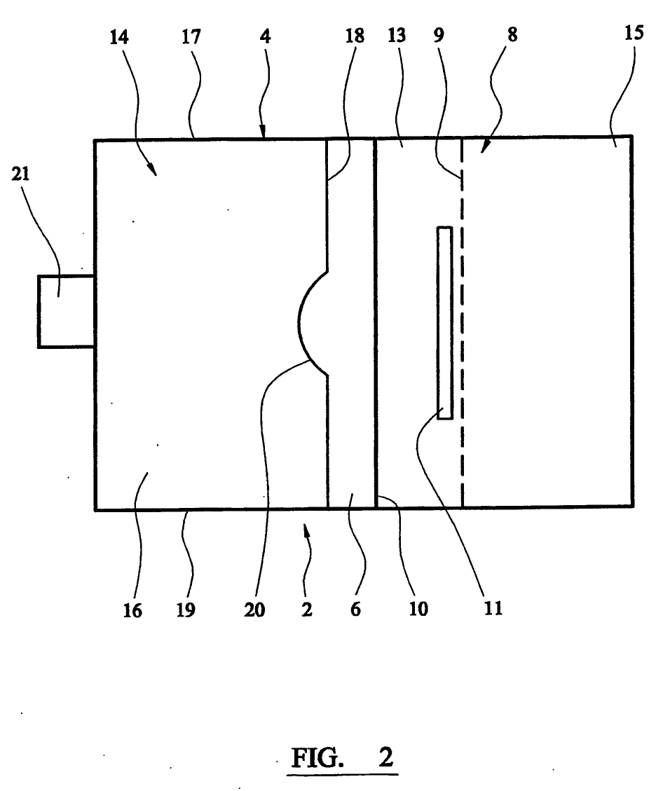

Referring firstly to FIGS. 1A and 2, a sheet article (2) of the present invention comprises a cover (4) comprising a first surface (8) and a second surface (6) formed from the same piece of material and hingedly connected therebetween by a fold (10).

The first surface (8) includes a line of weakness in the form of a line of perforations (9) running parallel with the fold line (10), along the entire width of the first surface (8), thereby dividing the first surface (8) into a first portion (13) which is always connected to the cover (4) via the fold line (10), and a second portion (15) which may be removed from the first surface (8) by tearing the line of perforations (9). The first surface (8) has connected thereto a sheet material in the form of a concertina folded sheet (12). The concertina folded sheet (12) is connected to the second portion (15) of the first surface (8).

The second surface (6) of the cover (4) comprises a pocket (14) formed on the inside of the second surface (6). The opening (18) of the pocket faces the fold (10) between the first and second surfaces. The pocket (14) comprises a pocket cover (16) formed by folding over a portion of the second surface (6) and gluing the side edges (17) and (19) of the folded over pocket cover (16) to the second surface (6), to form a pocket (14). In this configuration, the opening (18) of the pocket, faces towards the fold (10) between the first surface (8) and the second surface (6). The opening (18) also includes a thumb cut (20). The second surface (6) also comprises an adhesive securement tab (21) extending from the cover (4) at the opposite edge of the second surface (6) to the fold line (10).

Referring to FIG. 2, on the first portion (13) of the first surface (8), a strip of adhesive (11) is located adjacent to the line of perforations (9). The strip of adhesive (11) includes a removable silicone covering paper (not shown) which may be removed by a user to present the adhesive surface of the adhesive strip (11). The first portion (13) and adhesive strip (11) form a means for securely closing and sealing the pocket (14) when the second portion (15) is removed.

We refer now to FIG. 1B. The concertina folded sheet (12) comprises a first set of five concertina folds (22) and perpendicular to the folds (22), a second set of two concertina folds (24). Thus the sheet material (12) is divided up into six columns and three rows. An outermost corner segment (26) of the sheet (12) is connected to the second portion (15) of the first surface (8) of the cover (4) and the sheet material (12) folded up about the folds (22) and (24), such that the folded sheet material (12) is within the periphery of the first surface (8) of the cover (4).

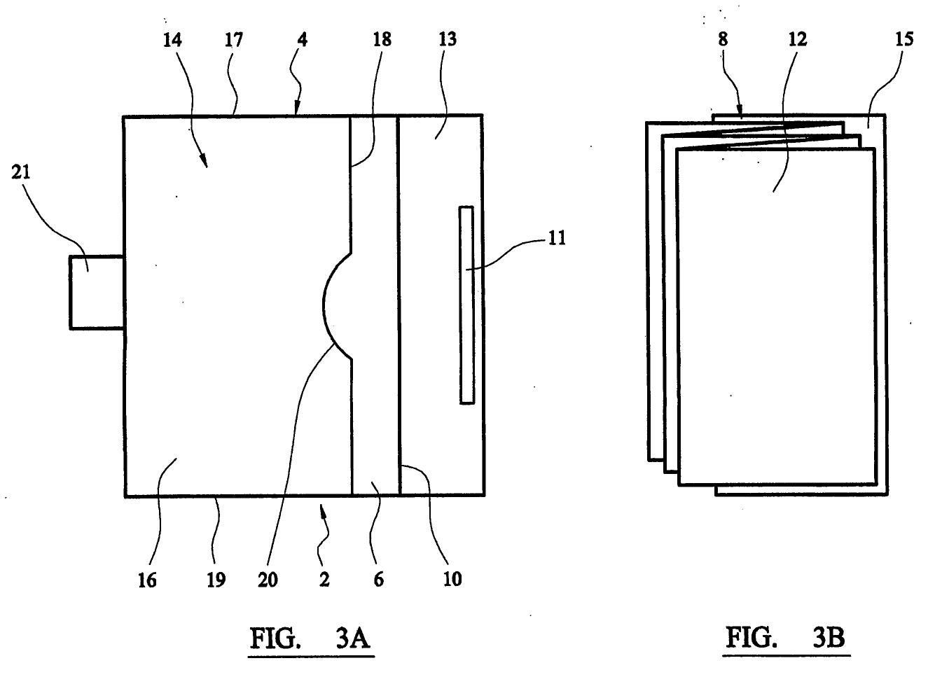

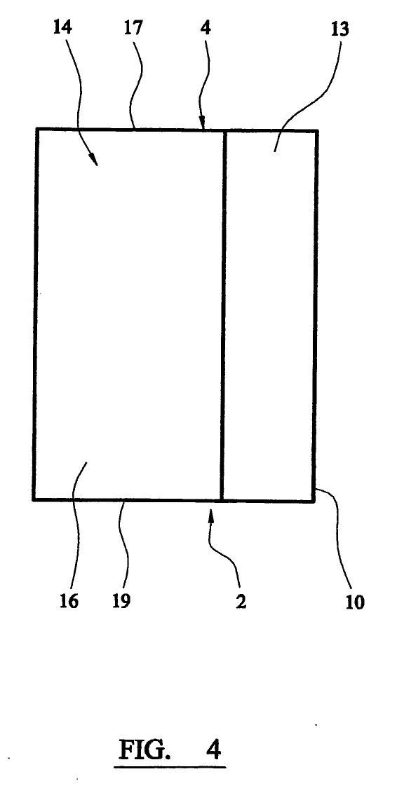

Use of the sheet article (2) will now be described with reference to FIGS. 3A, 3B and 4. In use, the sheet article is folded about the fold line (10), such that the first (8) and second (6) surfaces lie parallel and abutting. The securement tab (21) on the second surface (6) is then sealed to the outside of the first surface (8) to ensure that the first (8) and second (6) surfaces are securely held together. The sheet article (2) is then sent to a user, through postal delivery, the user's name and address being indicated on the outside of the second portion (15) of the first surface (8).

The user then releases the first (8) and second (6) surfaces by breaking the securement tab (21), and then unfolds the sheet article (2) about the fold line (10).

The second portion (15) of the first surface (8) is then removed from the cover (4) by tearing off the second portion (15) along the line of perforations (9).

The sheet article (12) is then unfolded about the first (22) and second (24) sets of concertina folds, such that the user is presents with a substantially flat sheet material (12). The first portion (25) of the sheet material (12) is then removed along the perforated concertina fold (28). The first portion (25) of the sheet article (12) may include spaces for the user to insert information, for example.

The second portion (27) of the sheet article (12) remains connected to the second portion (15) of the first surface (8) of the cover (4), to be retained by a user. The second portion (27) of the sheet material (12) could, for example, comprise written or printed information which a user may need to refer to and store for later reference. The first portion (25) of the sheet material (12) is then folded about the remaining concertina folds (22) and (24), and deposited within the pocket (14) on the second surface (6) of the cover (4).

The silicone cover paper (not shown) is then removed from the adhesive strip 11 on the first portion of the first surface, which remains integrally connected to the second surface (6) at the fold line (10) of the cover (4). The first portion (13) of the first surface (8) is then folded about the fold line (10), and the adhesive strip is pressed on to the front surface (16) of the pocket (14) in order to seal the pocket and securely retain the first portion (25) of the sheet material (12) within the pocket (14) as shown in FIG. 4. The front surface (16) of the pocket (14) can include, for example, the name and address of a third party to which the first portion (25) of the sheet material (12), which includes the users written or printed details, is desired to be sent. The sealed pocket (14) can then be posted by regular means to the third party.

In alternative embodiments of the sheet article (2) of the invention, the first and/or second surfaces (6) may include apertures formed therein, which enable the sheet article (2) or the first and/or second surfaces to be inserted into a ring binder or filofax, for example. The sheet material (12) may include, on the corner segment (26), printed or written information such as the users name and address, and the second portion (15) of the first surface (8), may include a cut-out portion through which the printed information on the corner segment (26) of the connected sheet material may be viewed, to aid in postal delivery. The cut-out portion of the second portion (15) of the first surface (8) may include a transparent cover, such as a transparent plastics material.

The sheet material (12) may also comprise a plurality of sheets connected to form a booklet, or a mixture of folded, concertina folded and/or booklet type sheet material. The sheet article (2), in alternative embodiments may include a pocket (14) which is divided into separate defined pocket portions each having a defined cavity and opening. The pocket portion openings may all face in the same direction, such as towards the fold line (10) of the cover (4). Alternatively there may be more than one pocket (14), each pocket (14) having an opening which may or may not face in the same direction as other pockets (14) of the sheet article (2).

In alternative embodiments of the invention, there may be a plurality of securement tabs extending from the cover (4) at intervals along the edge of the second surface (6) opposite to the fold line (10). In yet another alternative embodiment there may be a single continuous securement tab extending the entire length of the opposite edge of the second surface to the fold line (10).

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A sheet article comprising a cover comprising hingedly connected first and second surfaces, a sheet material being connected to the inside of the first surface, the second surface comprising a pocket, wherein the cover comprises a line of weakness such that at least a portion of the first surface is removable by separation of the cover at the line of weakness, and the article comprises means for securably closing the pocket.

2. A sheet article as claimed in claim 1, wherein a portion of the first surface, which portion includes the sheet material, is removable at the line of weakness.

3. A sheet article as claimed in claim 1, wherein the sheet material comprises a first set of folds.

4. A sheet article as claimed in claim 3, wherein the first set of folds is concertina folds.

5. A sheet article as claimed in claim 3, wherein the sheet material further comprises a second set of folds transverse to the first set of folds.

6. A sheet article as claimed in claim 5, wherein the second set of folds is concertina folds.

7. A sheet article as claimed in claim 1, wherein the sheet material is provided with a stiff portion at a segment thereof.

8. A sheet article as claimed in claim 1, wherein the sheet material is connected to the first surface at a segment of the sheet at one corner of the sheet, the segment being defined by fold(s) or edge(s) of the sheet.

9. A sheet article as claimed in claim 7, wherein the segment at which the stiff portion is provided is at another corner of the sheet material and is defined by fold(s) or edge(s) of the sheet.

10. A sheet article as claimed in claim 1, comprising a plurality of sheets which are connected to form a booklet.

11. A sheet article as claimed in claim 1, wherein the sheet material comprises a line of weakness, or indicator means, such that in use, at least a portion of sheet material may be separated at the line of weakness or indicator means, and may be inserted into the pocket of the sheet article.

12. A sheet article as claimed in claim 11, wherein the line of weakness is perforations.

13. A sheet article as claimed in claim 1, wherein the first and second surfaces are formed from a single surface comprising a fold therein, the fold forming the hinged connection between the first and second surfaces.

14. A sheet article as claimed in claim 1, wherein the pocket is formed from a portion of the second surface folded in on itself, and sealed to the second surface to form a pocket.

15. A sheet article as claimed in claim 1, wherein the pocket is formed from a separate surface connected to the second surface of the cover such that an opening is formed.

16. A sheet article as claimed in claim 1, wherein the pocket is formed such that it comprises no free edges within the interior of the pocket.

17. A sheet article as claimed in claim 1, wherein the pocket is connected to the inside of the second surface.

18. A sheet article as claimed in claim 1, wherein the opening of the pocket faces the hinged connection.

19. A sheet article as claimed in claim 1, wherein the means for securely closing the pocket comprises a pocket sealing means, whereby the pocket is sealable to provide a sealed pocket.

20. A sheet article as claimed in claim 1, wherein the means for securely closing the pocket comprises a portion of the cover which is movable to form a covering surface over the opening of the pocket.

21. A sheet article as claimed in claim 20, wherein the movable portion of the cover comprises the pocket sealing means, in order to seal the pocket.

22. A sheet article as claimed in claim 19, wherein the sealing means comprises an adhesive strip which comprises a detachable cover to prevent adhesion of the adhesive strip to the cover until desired.

23. A sheet article as claimed in claim 19, wherein the sealing means comprises a strip of material which, when wetted, becomes adhesive.

24. A sheet article as claimed in claim 1, wherein the line of weakness in the cover is provided in the hinged connection between the first and second surfaces.

25. A sheet article as claimed in claim 1, wherein the line of weakness in the cover is provided in the first surface.

26. A sheet article as claimed in claim 25, wherein the line of weakness in the first surface is oriented such that when a portion of the first surface is removed at the line of weakness, the remaining portion of the first surface is movable about the hinged connection to effect the covering surface over the opening of the pocket.

27. A sheet article as claimed in claim 1, wherein the sheet article is substantially credit-card sized, such that it may be retained in a pocket or wallet of a user.

28. A sheet article as claimed in claim 1, wherein the first surface comprises a cut-out portion over which the sheet material may be connected, such that information on the sheet material may be viewed through the cut-out portion.

29. (canceled)

30. A sheet article as claimed in claim 2, comprising a plurality of sheets which are connected to form a booklet.

31. A sheet article as claimed in claim 7, comprising a plurality of sheets which are connected to form a booklet.

32. A sheet article as claimed in claim 9, comprising a plurality of sheets which are connected to form a booklet.

33. A sheet article as claimed in claim 13, wherein the opening of the pocket faces the hinged connection.

34. A sheet article as claimed in claim 7, wherein the sheet material is connected to the first surface at a segment of the sheet at one corner of the sheet, the segment being defined by fold(s) or edge(s) of the sheet.

35. A sheet article as claimed in claim 34, wherein the segment at which the stiff portion is provided is at another corner of the sheet material and is defined by fold(s) or edge(s) of the sheet.
